(19) United States
(12) Patent Application Publication
(10) Pub. No.: US 2025/0248420 A1
(43) Pub. Date: Aug. 7, 2025

(54) METHOD FOR PRODUCING TEXTURED SOY PROTEIN COMPRISING RICE FLOUR AND TEXTURED SOY PROTEIN COMPRISING RICE FLOUR PRODUCED BY SAME METHOD

(71) Applicant: SOYMARU CO, LTD., Namyangju-si (KR)

(72) Inventor: Suk Woo MOON, Namyangju-si (KR)

(73) Assignee: SOYMARU CO, LTD., Namyangju-si (KR)

(21) Appl. No.: 19/187,327

(22) Filed: Apr. 23, 2025

Related U.S. Application Data
(63) Continuation of application No. PCT/KR2023/011604, filed on Aug. 7, 2023.

(30) Foreign Application Priority Data
Oct. 25, 2022 (KR) 10-2022-0138061

(51) Int. Cl. A23J 3/22; A23J 3/16; A23J 3/18; A23J 3/26

(52) U.S. Cl. CPC A23J 3/227; A23J 3/16; A23J 3/18; A23J 3/26

(57) ABSTRACT

The present invention relates to a textured soy protein comprising rice flour, comprising 58-80 wt % of a soy protein as solids, 9-22 wt % of rice flour, 8-18 wt % of wheat gluten, and 1-5 wt % of an additive. When an extrusion process for producing the textured soy protein is carried out, the tissue structure of the soy protein is changed by the rice flour and the wheat gluten, and thus, a textured soy protein with a softer and more elastic texture can be produced.

### CROSS-REFERENCE TO RELATED APPLICATIONS

The present application is a Continuation of International Application No. PCT/KR2023/011604 filed on Aug. 7, 2023, which is based upon and claims the benefit of priority to Korean Patent Application No. 10-2022-0138061 filed on Oct. 25, 2022, the entire contents of which are incorporated herein by reference.

### TECHNICAL FIELD

The present disclosure relates to a textured soy protein comprising rice flour and a method for producing the same, and more particularly, to a textured soy protein that is widely applicable in various food fields because it comprises rice powder to form a softer texture, and a method for producing the same.

### BACKGROUND ART

Protein is a major component of the body and is primarily obtained from meat, fish, and seafood, and can also be supplied to the human body through foods such as soybeans, nuts, and eggs.

Recently, a growing number of people have restricted their meat consumption for religious or health reasons, or have adopted a vegetarian diet for ethical or moral reasons. In addition, the market for plant-based meat alternatives has been rapidly expanding worldwide to solve global warming, food shortage, and animal welfare issues. As a result, research into plant-based meat alternatives that can replicate the texture, color, taste, and aroma of meat has been ongoing.

Among these, it has been considered a challenge to date because it requires a high level of technology to precisely replicate the texture of meat as it is. One way to mimic the texture of meat is to replicate the texture in meat alternatives, for this purpose, ‘beyond meat’ proposes a method of extruding proteins isolated from soybeans. In this method, the key technology is to make densely textured soy protein by controlling pressure, temperature, and speed during extrusion. The high temperature, high pressure, and shear force applied during extrusion forming cause the protein to dissolve, mix, and form a structure, resulting in texture and flavor similar to those of real meat, while reducing the bitterness and volatile compounds in soybeans.

However, when this method is used to meat alternatives called textured vegetable protein (TVP) or textured soy protein (TSP) that mimic the texture of meat, there is a problem that the texture of the meat alternatives is excessively firm and does not reproduce the soft texture of real meat. Accordingly, the use of the meat alternatives is limited and the versatility of the TVP or TSP is poor.

### DISCLOSURE

### Technical Problem

An object of the present disclosure is to provide a textured soy protein comprising rice flour, which has a softer texture and is widely applicable in various food fields, and a method for producing the same.

### Technical Solution

To solve the problems and technical challenges of the prior art as described above, in one embodiment of the present disclosure, a method for producing a textured soy protein comprising rice flour comprises: a raw material preparation step of producing a raw material mixture by mixing 58 to 80 wt % of a soy protein, 9.3 to 21.5 wt % of rice flour, 8.7 to 17.2 wt % of wheat gluten, and 1 to 5 wt % of a natural coloring additive as solids with 20 to 50 parts by weight of water based on 100 parts by weight of total weight of the solids; a forming step of producing a textured soy protein by placing the raw material mixture into an extrusion molding machine and extruding the raw material mixture at high temperature; and a drying step of drying the textured soy protein obtained by the forming step at 75 to 95° C. for 1 to 3 hours; wherein the soy protein is at least one of isolated soy protein, isolated mung bean protein, and isolated pea protein, and a content of moisture is preferably in a range of 1 to 10% relative to a content of the solids of the total textured soy protein through the drying step.

The raw material preparation step comprises mixing each raw material and stirring the raw material mixture at a speed of 1,000 to 2,000 RPM for 1 to 3 hours. The forming step is preferably performed at 120 to 140° C., and the natural coloring additive is more preferably at least one selected from the group consisting of cocoa powder, cactus powder, prickly pear powder, turmeric powder, gardenia powder, pumpkin powder, green algae powder, spinach powder, and mugwort powder.

In another embodiment of the present disclosure, there is provided a textured soy protein comprising rice flour produced by the method as described above.

### Advantageous Effects

The textured soy protein comprising rice flour of the present disclosure has the advantage of being able to replace various types of meat due to its soft texture.

### BEST MODE

Before explaining a preferred embodiments of the present disclosure in detail below, it should be noted that the terms or words used in the present specification and claims are not to be construed in their ordinary or dictionary meanings, but are to be construed as meaning and concepts meeting the technical spirit of the present disclosure.

Throughout the present specification, “including” any component will be understood to imply the inclusion of other components rather than the exclusion of other components, unless otherwise specifically stated.

Throughout the present specification, “%” used to indicate a concentration of a specific material refers to (weight/weight) % for solid/solid, (weight/volume) % for solid/liquid, and (volume/volume) % for liquid/liquid, unless otherwise stated.

The steps may be performed in any order other than that specified, unless the context clearly indicates a specific order. That is, the steps may be performed in the same order as the specified order, may be performed substantially simultaneously, or may be performed in reverse order.

Hereinafter, an embodiment of the present disclosure will be described. However, the scope of the present disclosure is not limited to the following preferred embodiment, and those skilled in the art may perform various modified forms of the contents described in the present specification without departing from the scope of the present disclosure.

The present disclosure relates to meat alternatives called textured vegetable protein (TVP) or textured soy protein (TSP) that mimic the texture of meat and a method for producing the same, and more specifically, to a textured soy protein comprising rice flour and a method for producing the same.

First, one embodiment of the present disclosure relates to a textured soy protein comprising rice flour, wherein the textured soy protein comprising rice flour may comprise a soy protein, rice flour, wheat gluten, and an additive, and specifically 58 to 80 wt % of a soy protein, 9 to 22 wt % of rice flour, 8 to 18 wt % of wheat gluten, and 1 to 5 wt % of an additive, and may further comprise 10% or less of water in the total textured soy protein as a percentage of the solid content. Here, the solids refer to all other components except water.

Generally, the textured soy protein has the characteristics of shape, mouthfeel, texture, textural properties, and cohesiveness similar to those of meat by extruding a protein isolated from plants, i.e., an isolated protein such as a soy protein, at high temperature and high pressure to reconstruct the structure of the protein, thereby replicating the texture of meat.

However, when soy protein is extruded alone, a firmer texture than real meat is formed, and it is difficult to form textural properties of meat with a soft and elastic texture. Therefore, by including a soy protein, rice flour, wheat gluten, and an additive in the materials for forming a textured soy protein, the present disclosure aims to provide a textured soy protein that is more similar in appearance such as color and shape to real meat, and has the same softness and elasticity as real meat.

The textured soy protein thus formed has the advantage of having softness and elasticity close to real meat, and when the textured soy protein is used to cook plant-based meat products, the soft and elastic texture continues to be maintained even when the plant-based meat products are cooled over time after cooking, making it a valuable source of raw plant-based meat for plant-based meat products, compared to the disadvantage of a firm and tough texture of cooled plant-based meat products in general.

The soy protein included in the textured soy protein comprising rice flour of the present disclosure is an isolated plant protein isolated from soybeans, and may be at least one of isolated soy protein, isolated mung bean protein, and isolated pea protein.

This soy protein is the most important component that determines a basic structure of the textured soy protein, and may be included in an amount of 58 to 80 wt %. If the soy protein is included in less than 58 wt %, it is difficult to produce a certain type of textured soy protein because the bond between the soy proteins is insufficient and sufficient strength to maintain the form of the textured soy protein is not secured. If the soy protein is included in excess of 80 wt %, there is a problem that the soft and elastic texture of the textured soy protein is not formed, and it is still formed with an excessively firm texture.

The rice flour is added to absorb moisture and make the tissue of the textured soy protein soft and tender, thereby replicating a soft mouthfeel closer to that of meat. In addition, when the rice flour is added, the moisture content in the textured soy protein is maintained at a high level, so when the textured soy protein is used to cook plant-based meat dishes, for example, plant-based bulgogi, the soft texture continues to be maintained even after the plant-based bulgogi has cooled down for some time after cooking.

The rice flour may be included in a range of 9 to 22 wt %, and preferably 9.3 to 21.5 wt %. If the rice flour is included in less than 9 wt %, a sufficiently soft texture is not achieved. If the rice flour is included in excess of 22 wt %, the protein structure of the textured soy protein is excessively softened, resulting in difficulty in maintaining the shape or rather a poor mouthfeel, so it is preferable added within the weight range described above.

By forming a gluten structure during the production of the textured soy protein, the wheat gluten may promote the organization of the protein structure in the textured soy protein while simultaneously increasing its elasticity, thereby providing an elastic and chewy texture and mouthfeel, compared to the conventional textured soy protein which simply has a firm texture and mouthfeel.

The wheat gluten may be included in a range of 8 to 18 wt %, preferably 8.7 to 17.2 wt %. If the content of wheat gluten is less than 8 wt %, it is difficult to achieve sufficient elasticity similar to that of meat. if the content of what gluten exceeds 18 wt %, there is a problem of excessive elasticity, so it is preferable included within the weight range described above.

The additive is a component that is added to make the appearance or shape of the textured soy protein more similar to that of meat, and may include a coloring matter. Preferably, a natural coloring matter may be used as the coloring matter, for example, but is not limited thereto, at least one of cocoa powder, cactus powder, prickly pear powder, turmeric powder, gardenia powder, pumpkin powder, green algae powder, spinach powder, and mugwort powder.

The additive may be included in the textured soy protein in an amount of 1 to 5 wt %. If the additive is added at less than 1 wt %, the effect of the additive is negligible. If the additive is added in excess of 5 wt %, there is a problem that the additive has an excessive effect, resulting in a deterioration of the appearance or shape of the meat, and an adverse effect on the texture and taste, so it is preferable to include it within the weight range described above.

The textured soy protein is generally distributed in a dried state, and is used after being hydrated before cooking, and may be applied to various plant-based meat dishes such as bulgogi, tteokgalbi, steak, hamburger patties, pork cutlets, and meat toppings for various dishes, depending on the seasoning or recipe, and may provide a texture almost identical to that of meat such as chicken breast, which is widely used as a diet food, in particular.

Another disclosure embodiment of the present comprises a method for producing a textured soy protein comprising rice flour, the method comprising: a raw material preparation step of producing a raw material mixture by mixing a soy protein, rice flour, wheat gluten, and an additive with each other; a forming step of producing a textured soybean protein by placing the raw material mixture into an extrusion molding machine and extruding the raw material mixture at high temperature; and a drying step of drying the textured soy protein obtained by the forming step.

The raw material preparation step comprises producing a raw material mixture by mixing a soybean protein, rice flour, wheat gluten, and an additive with water. The soy protein, rice flour, wheat gluten, and additive used in this step are the same as those previously described in one embodiment of the present disclosure, and therefore redundant descriptions will be omitted.

In the raw material preparation step, the solids comprising a soy protein, rice flour, wheat gluten, and an additive may be mixed in a weight ratio of 58 to 80 wt % of a soy protein, 9 to 22 wt % of rice flour, 8 to 18 wt % of wheat gluten, and 1 to 5 wt % of an additive, or may be mixed in a weight ratio of 58 to 80 wt % of a soy protein, 9.3 to 21.5 wt % of rice flour, 8.7 to 17.2 wt % of wheat gluten, and 1 to 5 wt % of an additive, and water may be added in a range of 20 to 50 parts by weight based on 100 parts by weight of total weight of the solids.

In the raw material preparation step, each raw material may be mixed and then stirred at a speed range of about 1,000 to 2,000 RPM for about 1 to 3 hours to form a raw material mixture. Here, if the mixing speed is below the above speed range or the stirring time is below the above time, sufficient mixing of each raw material and formation of gluten structure are insufficient, resulting in a decrease in the textural property of the textured soy protein. If the stirring is performed quickly exceeding the above speed, the amount of air mixed in the raw material increases and bubbles are formed, which is not preferable.

In addition, if the stirring is performed beyond the time described above, there is a problem that excessive gluten formation may result in a poor mouthfeel or texture, so it is preferable that the stirring is performed under the conditions described above.

The forming step comprises placing the raw material mixture into an extrusion molding machine and extruding the raw material mixture at high temperature. In this step, the protein structure of the raw material mixture is reconstructed to replicate textural properties and mouthfeel similar to those of meat.

In this step, an injection temperature of the extrusion molding machine may be 120 to 140° C. If it is below 120° C., it is difficult to form sufficient textural properties. If it exceeds 140° C., there is a problem of carbonization, so it is preferable that the extrusion process is performed under the temperature conditions described above.

The drying step comprises drying the textured soy protein obtained by the forming step to adjust the moisture content and stabilize the structure of the textured soy protein, and may be drying at 75 to 95° C. for 1 to 3 hours.

Here, if the drying temperature is below the above range, the drying time increases and the productivity decreases. If the drying process is performed at a temperature higher than 95° C., the difference in moisture content between the surface and the interior may cause a deterioration in mouthfeel. In addition, if the drying time is beyond the above range, sufficient drying may not occur or productivity may be reduced, so it is preferable that the drying process s is performed under the conditions described above.

After drying, the moisture content may be 10% or less, preferably 1 to 10%. When the moisture content is maintained within this range, the denaturation of the protein by moisture during distribution or storage may be effectively prevented.

Since the textured soy protein obtained by these steps is in a dried state, it may be packaged and distributed in this state, hydrated before cooking, and may be applied to various plant-based meat dishes such as bulgogi, tteokgalbi, steak, hamburger patties, pork cutlets, and meat toppings for various dishes, depending on the seasoning or recipe.

Hereinafter, one embodiment of the present disclosure will be described to illustrate the specific actions and effects of the present disclosure. However, this is merely a preferable example of the present disclosure, and does not limit the scope of the present disclosure according to the embodiments.

### Preparation Example

Isolated soy protein, rice flour, wheat gluten, and cocoa powder were prepared, and mixed in a mixing ratio of Table 1 below. Then, 30 parts by weight of water was added to each mixture based on 100 parts by weight of the total content of the mixture, and the resulting mixture was stirred at a speed of 1, 500 RPM for 1 hour to prepare a raw material mixture.

Then, the raw material mixture was placed into an extrusion molding machine with an injection temperature set to 130±2° C. and extruded to produce a textured soy protein. The textured soy protein was dried in a hot air dryer at 85±3° C. for 2 hours to produce a textured soy protein comprising rice flour.

### Experimental Example 1

First, using the textured soy protein produced with 100% isolated soy protein as a control example, the force required to cut the specimens of the Examples and Comparative Examples prepared by varying the contents of rice flour, wheat gluten, and cocoa powder as shown in Table 1 was measured. The results are shown in Table 1. For each specimen, the cutting force was measured both in a dried state (dry) and a state steamed for 20 minutes (wet), with Control Example 1 being a specimen prepared only with isolated soy protein, and Control Example 2 being chicken breast from a commercially available chicken.

The cutting force was measured by preparing a specimen by cutting each textured soy protein into 1 cm in thickness, 1 cm in width and 1 cm in length, and measuring the force applied when cutting the specimen at a strain of 80 and a speed of 2 mm/s using a material property measuring device (TA. XT Plus, Stable Micro Systems).

The cutting force in the dry state of Control Example 2 was measured after drying the chicken breast from commercially available chicken at 75 to 95° C. for 1 to 3 hours, and the cutting force in the wet state was measured after steaming for 20 minutes in the same manner as in Examples 1 to 3 and Comparative Examples 1 to 4.

TABLE 1

| | Composition ratio (% by weight) | | | | | |
|---|---|---|---|---|---|---|
| | Isolated | | | | | |
| | soy | Rice | Wheat | Cocoa | Cutting force (N) | |
| | protein | flour | gluten | powder | Dry | Wet |
| Control | 100.0 | — | — | — | 44.3 ± 1.5 | 21.0 ± 0.9 |
| Example 1 | | | | | | |
| Control | — | — | — | — | 20.8 ± 1.1 | 10.2 ± 0.5 |
| Example 2 | | | | | | |
| Comp. | 79.7 | — | 18.0 | 2.3 | 42.7 ± 1.7 | 19.8 ± 1.1 |
| Example 1 | | | | | | |
| Comp. | 79.5 | 18.3 | — | 2.2 | 31.0 ± 2.3 | 18.9 ± 1.1 |
| Example 2 | | | | | | |
| Comp. | 70.8 | 7.8 | 19.0 | 2.4 | 28.4 ± 1.8 | 17.2 ± 1.2 |
| Example 3 | | | | | | |
| Example | 70.1 | 9.3 | 17.7 | 2.9 | 20.6 ± 1.3 | 10.5 ± 1.0 |
| 2 | | | | | | |
| Example | 70.3 | 14.9 | 12.3 | 2.5 | 20.0 ± 2.1 | 9.9 ± 1.4 |
| 1 | | | | | | |
| Example | 66.7 | 21.5 | 8.7 | 3.1 | 19.7 ± 1.5 | 9.7 ± 0.9 |
| 3 | | | | | | |
| Comp. | 66.0 | 22.9 | 8.1 | 3.0 | 18.6 ± 1.2 | 5.1 ± 1.3 |
| Example 4 | | | | | | |

As a result of the experiment of Experimental Example 1, it was found that when the textured soy protein was produced by adding isolated soy protein, rice flour, and wheat gluten, the cutting force was about half of that of the textured soy protein produced by isolated soy protein alone, forming soft textural properties.

Specifically, when comparing Control Example 1 with Comparative Example 1 and Comparative Example 2, it can be confirmed that when rice flour was used alone as an additive, the texture was softer than when isolated soy protein was used alone, and when wheat gluten was used alone as an additive, it had no significant effect on the softness.

In addition, when comparing Examples 1 to 3, Comparative Example 3, and Comparative Example 4 together, when the content of rice flour was insufficient as in Comparative Example 3, the softening effect was not sufficiently shown, and when the content of rice flour was excessive as in Comparative Example 4, the cutting force was good when dry, but the cutting force is excessively weakened when wet, making it difficult to maintain the shape.

As a result of the present experiment, it can be confirmed found that it is preferable to produce the textured soy protein by extruding the isolated soybean protein with rice flour and wheat gluten to form soft textural properties of the textured soy protein, in particular, when the content of rice flour content is 9 to 22 wt %, and more preferably 9.3 to 21.5 wt %, it is possible to replicate the texture of soft meat without collapse of the tissue shape in the wet state.

### Experimental Example 2

First, the textured soy proteins of Control Example 1, Example 1, Comparative Example 1, and Comparative Example 2, which are the same as Experimental Example 1, and the textured soy proteins with the contents of rice flour and wheat gluten added to the textured soy protein varied as shown in Table 2, were produced, and the food properties were measured. The results are shown in Table 3.

The food properties were measured using a material measuring device (Model CT3-10 kg, Brookfield) under the conditions of a strain of 60% and a speed of 2 mm/s after forming the sample, the textured soy protein, to have 3 cm in diameter and 0.2 cm in height. Each sample was measured in triplicate and statistically processed by Duncan's method, and the obtained statistical values (mean values) are listed in Table 2.

TABLE 2

Composition ratio (parts by weight)

| | Isolated | Rice | Wheat | Cocoa |
|---|---|---|---|---|
| | soy protein | flour | gluten | powder |
| Control | 100.0 | — | — | - |
| Example 1 | | | | |
| Comp. | 79.7 | — | 18.0 | 2.3 |
| Example 1 | | | | |
| Comp. | 79.5 | 18.3 | — | 2.2 |
| Example 2 | | | | 4 |
| Comp. | 72.4 | 18.4 | 7.1 | 2.1 |
| Example 5 | | | | |
| Example 4 | 71.2 | 17.8 | 8.7 | 2.3 |
| Example 1 | 70.3 | 14.9 | 12.3 | 2.5 |
| Example 5 | 67.2 | 13.2 | 17.2 | 2.4 |
| Comp. | 65.9 | 12.5 | 19.0 | 2.6 |
| Example 6 | | | | |

TABLE 3

| | Hardness (N) | Springiness | Cohesiveness | Gumminess | Chewiness |
|---|---|---|---|---|---|
| Control | 24.0 | 0.9 | 1.3 | 31.1 | 26.2 |
| Example 1 | | | | | |
| Comp. | 23.1 | 0.9 | 1.0 | 30.5 | 26.0 |
| Example 1 | | | | | |
| Comp. | 21.4 | 0.8 | 1.0 | 31.2 | 24.7 |
| Example 2 | | | | | |
| Comp. | 20.3 | 0.9 | 1.1 | 31.1 | 25.3 |
| Example 5 | | | | | |
| Example 4 | 19.2 | 0.8 | 1.5 | 30.9 | 26.1 |
| Example 1 | 18.8 | 0.8 | 1.6 | 30.6 | 24.0 |
| Example 5 | 19.5 | 0.8 | 1.6 | 30.6 | 23.4 |
| Comp. | 22.6 | 0.8 | 1.7 | 30.4 | 24.4 |
| Example 6 | | | | | |

Referring to the results in Table 3 above, it was found that wheat gluten and rice flour affected the hardness and cohesiveness of the textured soy protein, resulting in changes in textual properties and mouthfeel. Specifically, it can be confirmed that Example 1, Example 4, and Example 5 had a softer texture due to lower hardness and an elastic texture due to stronger cohesiveness, compared to the Control Examples and Comparative Examples, while the cohesiveness decreased when the content of wheat gluten was insufficient, as in Example 5, and the hardness was too high when the content of wheat gluten was excessive, as in Example 6.

Therefore, it can be confirmed from the present experimental results that in order to form a soft and elastic meat texture, it is preferable to add isolated soy protein, rice flour, and wheat gluten when producing textured soy protein, and in particular, it is preferable that the content of wheat gluten is 8 to 18 wt %.

### INDUSTRIAL APPLICABILITY

The present disclosure relates to a textured soy protein comprising rice flour, which has a soft texture and is widely applicable in various food fields, and a method for producing the same. The present disclosure provides the textured soybean protein comprising rice flour by a raw material preparation step of producing a raw material mixture by mixing 58 to 80 wt % of a soy protein, 9.3 to 21.5 wt % of rice flour, 8.7 to 17.2 wt % of wheat gluten, and 1 to 5 wt % of a natural coloring additive as solids with 20 to 50 parts by weight of water based on 100 parts by weight of total weight of the solids; a forming step of producing a textured soy protein by placing the raw material mixture into an extrusion molding machine and extruding the raw material mixture at high temperature; and a drying step of drying the textured soy protein obtained by the forming step at 75 to 95° C. for 1 to 3 hours, and thus has industrial applicability.

1. A method for producing a textured soy protein comprising rice flour, comprising:
a raw material preparation step of producing a raw material mixture by mixing 58 to 80 wt % of a soy protein, 9.3 to 21.5 wt % of rice flour, 8.7 to 17.2 wt % of wheat gluten, and 1 to 5 wt % of a natural coloring additive as solids with 20 to 50 parts by weight of water based on 100 parts by weight of total weight of the solids;
a forming step of producing a textured soy protein by placing the raw material mixture into an extrusion molding machine and extruding the raw material mixture at high temperature; and
a drying step of drying the textured soy protein obtained by the forming step at 75 to 95° C. for 1 to 3 hours,
wherein the soy protein is at least one of isolated soy protein, isolated mung bean protein, and isolated pea protein, and
a content of moisture is in a range of 1 to 10% relative to a content of the solids of the total textured soy protein through the drying step.

2. The method of claim 1, wherein the raw material preparation step comprises mixing each raw material and stirring the raw material mixture at a speed of 1,000 to 2,000 RPM for 1 to 3 hours.

3. The method of claim 1, wherein the forming step performed at 120 to 140° C.

4. The method of claim 1, wherein the natural coloring additive is at least one selected from the group consisting of cocoa powder, cactus powder, prickly pear powder, turmeric powder, gardenia powder, pumpkin powder, green algae powder, spinach powder, and mugwort powder.

5. A textured soy protein comprising rice flour produced by the method of claim 1.

6. A textured soy protein comprising rice flour produced by the method of claim 2.

7. A textured soy protein comprising rice flour produced by the method of claim 3.

8. A textured soy protein comprising rice flour produced by the method of claim 4.
